(19) United States
(12) Patent Application Publication
(10) Pub. No.: US 2026/0016362 A1
(43) Pub. Date: Jan. 15, 2026

(54) SYSTEMS AND METHODS FOR GAS QUALITY MONITORING OF SMART GAS PIPELINE NETWORKS BASED ON AN INTERNET OF THINGS

(71) Applicant: CHENGDU QINCHUAN IOT TECHNOLOGY CO., LTD., Chengdu (CN)

(72) Inventors: Zehua SHAO, Chengdu (CN); Yong LI, Chengdu (CN); Bin LIU, Chengdu (CN); Feng WANG, Chengdu (CN); Yunbai CHEN, Chengdu (CN)

(73) Assignee: CHENGDU QINCHUAN IOT TECHNOLOGY CO., LTD., Chengdu (CN)

(21) Appl. No.: 19/337,878

(22) Filed: Sep. 23, 2025

(30) Foreign Application Priority Data
Aug. 4, 2025 (CN) 202511082470.1

(51) Int. Cl. G01M 3/28; G06Q 10/067; G06Q 50/06

(52) U.S. Cl. CPC G01M 3/2807; G06Q 10/067; G06Q 50/06

(57) ABSTRACT

Systems and methods for gas quality monitoring are provided. The system includes a government gas supervision management platform, a government gas supervision sensing network platform, a government gas supervision object platform, a gas company sensing network platform, a device object platform, a gas user platform, and a gas company service platform communicated with each other. The government gas supervision management platform is configured to determine a monitoring sampling region based on the first gas data; determine a monitoring frequency of a gas monitoring device within the monitoring sampling region based on a steady-state value of the monitoring sampling region; determine a terminal gas quality based on the second gas data and the gas input information; determine a gas quality requirement based on the terminal user feature and the gas regulation data; and determine an updating mixing parameter in response to the terminal gas quality not satisfying the gas quality requirement.

### CROSS-REFERENCE TO RELATED APPLICATIONS

This application claims the priority of Chinese Patent Application No. 202511082470.1, filed on Aug. 4, 2025, the contents of which are hereby incorporated by reference.

### TECHNICAL FIELD

The present disclosure relates to the field of gas quality monitoring, and in particular relates to systems and methods for gas quality monitoring of smart gas pipeline networks based on an Internet of Things (IoT).

### BACKGROUND

In the gas supply system, manual monitoring and other methods are usually used for gas quality monitoring, which is inefficient, costly in terms of manpower and material resources, and difficult to meet the high requirements of modern city management for gas safety and accuracy. With the development of the Internet of Things (IoT) technology, intelligent monitoring and management of gas quality have become possible.

Therefore, it is desirable to provide a system and method for gas quality monitoring of smart gas pipeline networks based on an Internet of Things (IoT) to realize accurate monitoring of gas quality and dynamic adjustment of gas mixing ratio through data exchange between platforms in the IoT, thereby ensuring the gas usage of gas users.

### SUMMARY

One or more embodiments of the present disclosure provide a system for gas quality monitoring of smart gas pipeline networks based on an Internet of Things (IoT), wherein the system comprises a government gas supervision management platform, a government gas supervision sensing network platform, a government gas supervision object platform, a gas company sensing network platform, a device object platform, a gas user platform, and a gas company service platform communicated with each other. The government gas supervision object platform includes a gas company management platform; wherein the government gas supervision management platform is configured to: obtain first gas data via the device object platform, and determine a monitoring sampling region based on the first gas data; determine a monitoring frequency of a gas monitoring device within the monitoring sampling region based on a steady-state value of the monitoring sampling region; obtain second gas data and gas input information via the device object platform, and determine a terminal gas quality based on the second gas data and the gas input information; obtain a terminal user feature from the gas user platform via the gas company service platform; obtain gas regulation data via the device object platform, and determine a gas quality requirement based on the terminal user feature and the gas regulation data; determine an updating mixing parameter in response to the terminal gas quality not satisfying the gas quality requirement; and generate an updating mixing instruction based on the updating mixing parameter, and send the updating mixing instruction to the gas company management platform, wherein the gas company management platform updates a mixing parameter of a gas mixing device.

One or more embodiments of the present disclosure provide a method for gas quality monitoring of smart gas pipeline networks based on an Internet of Things (IoT), wherein the method is executed by a government gas supervision management platform in a system for gas quality monitoring of smart gas pipeline networks based on an Internet of Things (IoT), the method comprising: obtaining first gas data via a device object platform, and determining a monitoring sampling region based on the first gas data; determining a monitoring frequency of a gas monitoring device within the monitoring sampling region based on a steady-state value of the monitoring sampling region; obtaining second gas data and gas input information via the device object platform, and determining a terminal gas quality based on the second gas data and the gas input information; obtaining a terminal user feature from the gas user platform via the gas company service platform; obtaining gas regulation data via the device object platform, and determining a gas quality requirement based on the terminal user feature and the gas regulation data; determining an updating mixing parameter in response to the terminal gas quality not satisfying the gas quality requirement; and generating an updating mixing instruction based on the updating mixing parameter, and sending the updating mixing instruction to the gas company management platform, wherein the gas company management platform updates a mixing parameter of a gas mixing device.

One or more embodiments of the present disclosure provide a non-transitory computer-readable storage medium storing computer instructions, wherein, when reading the computer instructions in the storage medium, a computer implements a method for gas quality monitoring of smart gas pipeline networks based on an Internet of Things (IoT).

### BRIEF DESCRIPTION OF THE DRAWINGS

This disclosure will be further illustrated by way of exemplary embodiments, which will be described in detail by means of the accompanying drawings. These embodiments are not limiting, and in these embodiments, the same numbering denotes the same structure, wherein:

FIG. 1 is a schematic diagram of a platform structure of a system for gas quality monitoring of smart gas pipeline networks based on an Internet of Things (IoT) according to some embodiments of the present disclosure;

FIG. 2 is a flowchart illustrating an exemplary process for gas quality monitoring of smart gas pipeline networks based on an Internet of Things (IoT) according to some embodiments of the present disclosure;

FIG. 3 is a flowchart illustrating an exemplary process for determining a terminal gas quality according to some embodiments of the present disclosure; and

FIG. 4 is a schematic diagram illustrating an exemplary estimation model according to some embodiments of the present disclosure.

### DETAILED DESCRIPTION

In order to more clearly illustrate the technical solutions of the embodiments of the present disclosure, a brief description of the accompanying drawings that need to be used in the description of the embodiments is provided below. The accompanying drawings do not represent the entirety of the embodiments.

It should be understood that, as used herein, “system,” “device,” “unit,” and/or “module” as used herein refers to a way to distinguish between different components, elements, parts, sections, or assemblies at different levels. The words may be replaced by other expressions if other words accomplish the same purpose.

When describing the operations performed in the embodiments of the present disclosure in a step-by-step fashion, the order of the steps is interchangeable, the steps can be omitted, and other steps can be included in the operation if not otherwise specified.

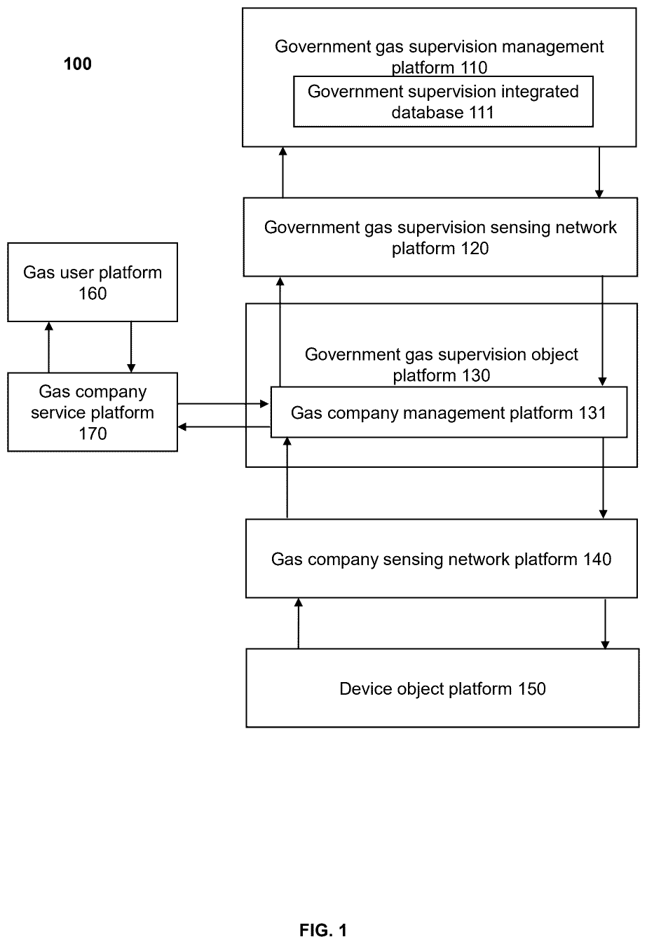

FIG. 1 is a schematic diagram of a platform structure of a system for gas quality monitoring of smart gas pipeline networks based on an Internet of Things (IoT) according to some embodiments of the present disclosure.

As shown in FIG. 1, a system 100 for gas quality monitoring of smart gas pipeline networks based on an Internet of Things (IoT) includes a government gas supervision management platform 110, a government gas supervision sensing network platform 120, a government gas supervision object platform 130, a gas company sensing network platform 140, a device object platform 150, a gas user platform 160, and a gas company service platform 170 communicated with each other.

The government gas supervision management platform refers to a comprehensive management platform for the government to manage information related to gas quality. In some embodiments, the government gas supervision management platform is configured as a server or processor. The government gas supervision management platform further includes a government supervision integrated database 111. The government supervision integrated database is configured to store information or data related to the gas pipeline network. For example, pipeline information, a pipeline cleaning cycle, or the like.

The government gas supervision sensing network platform refers to a platform for comprehensive management of government sensing information. In some embodiments, the government gas supervision sensing network platform is configured as a communication network or gateway, etc. The government gas supervision sensing network platform may interact with the government gas supervision management platform and the government gas supervision object platform.

The government gas supervision object platform refers to a platform for generating and controlling the execution of government supervision information. In some embodiments, the government gas supervision object platform includes a gas company management platform 131. The gas company management platform refers to a comprehensive management platform for gas company information. The gas company management platform is configured as a server or processor.

The gas company sensing network platform refers to a platform used for comprehensive management of sensing information of a gas company. In some embodiments, the gas company sensing network platform is configured as a communication network or gateway, etc. The gas company sensing network platform may interact with the gas company management platform and the device object platform.

The device object platform refers to a functional platform for sensing information generation and controlling information execution. In some embodiments, the device object platform includes a gas monitoring device, a gas mixing device, an odorizing device, a hydrogen blending device, a gas entry device, etc. The gas monitoring device includes a temperature sensor, a pressure sensor, a flow meter, etc. The gas mixing device is installed at the branch outlet of the pipeline to mix the gas delivered by an upstream pipeline and to deliver the blended gas to the user or a downstream pipeline. The gas monitoring device, the odorizing device, and the hydrogen blending device are installed at any feasible location, such as at the gas mixing device.

In some embodiments, the gas entry device includes a leak monitoring device, a gas meter or gas valve, an image sensor, a carbon monoxide sensor, a carbon dioxide sensor, etc.

The gas company service platform refers to a platform for the gas company to provide gas consumption services to gas users. In some embodiments, the gas company service platform is configured as a server or processor.

The gas user platform refers to a platform for interacting with gas users. In some embodiments, the gas user platform includes a terminal device. The terminal device includes a mobile device, a tablet, or the like.

In some embodiments, the system 100 for gas quality monitoring of smart gas pipeline networks based on an Internet of Things (IoT) may further include a processor. The processor is configured to process information and/or data related to the system 100 for gas quality monitoring of smart gas pipeline networks based on an Internet of Things (IoT). The processor may include a central processing unit (CPU), a specialized instruction processor (ASIP), a graphics processor (GPU), a digital signal processor (DSP), etc., or any combination thereof.

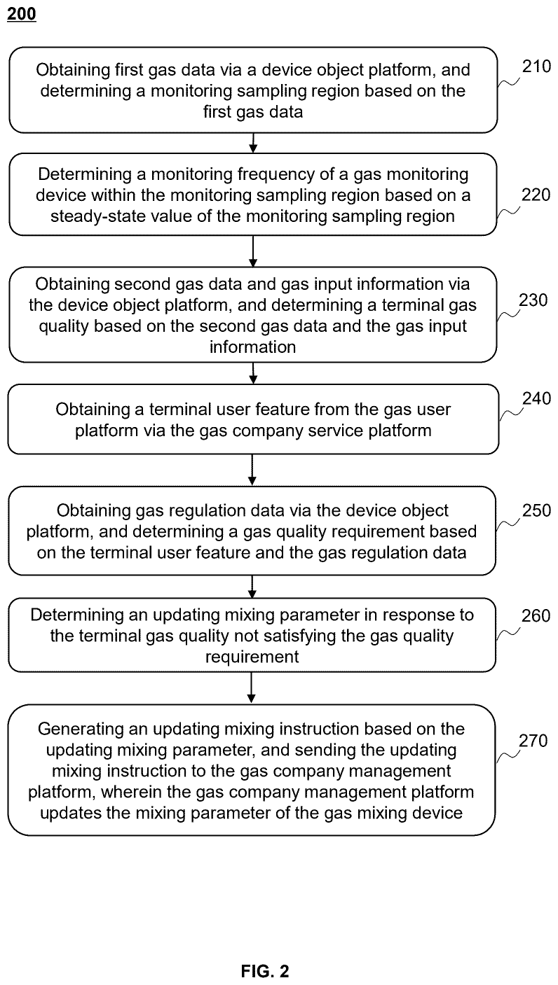

Detailed descriptions of the foregoing may be found in the related descriptions of FIG. 2 to FIG. 4.

The system for gas quality monitoring of smart gas pipeline networks based on an Internet of Things (IoT) can form a closed loop of information operation between various functional platforms, coordinate and operate regularly, and realize the informatization and intelligence of gas quality monitoring of smart gas pipeline networks.

FIG. 2 is a flowchart illustrating an exemplary process for gas quality monitoring of smart gas pipeline networks based on an Internet of Things (IoT) according to some embodiments of the present disclosure. In some embodiments, the process 200 may be performed by a government gas supervision management platform (hereinafter referred to as a supervision management platform) of a system for gas quality monitoring of smart gas pipeline networks based on an Internet of Things (IoT). As shown in FIG. 2, the process 200 includes the following operations.

More descriptions regarding the system for gas quality monitoring of smart gas pipeline networks based on an Internet of Things (IoT) may be found in FIG. 1 and the relevant descriptions.

In 210, first gas data is obtained via a device object platform, and a monitoring sampling region is determined based on the first gas data.

The first gas data refers to global gas data corresponding to the gas pipeline network obtained by the device object platform based on a low sampling rate. The global gas data corresponding to the gas pipeline network refers to gas data for each location in the gas pipeline network.

The gas data is data related to the gas in the pipeline. In some embodiments, the gas data includes at least one of a gas temperature, a gas pressure, and a gas flow rate. The gas data is obtained via a gas monitoring device.

In some embodiments, the device object platform acquires the gas data collected by the gas monitoring device at various locations in the gas pipeline network based on a low sampling rate to obtain the first gas data, and the first gas data is uploaded to the supervision management platform via a gas company sensing network platform, a government gas supervision object platform, and a government gas supervision sensing network platform. The sampling rate refers to the frequency with which the device object platform obtains the gas data from the gas monitoring device. The low sampling rate refers to a sampling rate that is below a first sampling threshold. A high sampling rate refers to a sampling rate that is higher than a second sampling threshold. The first sampling threshold and the second sampling threshold are preset based on experience, and the second sampling threshold is higher than the first sampling threshold.

The monitoring sampling region refers to a gas pipeline network region in which a monitoring frequency of the gas monitoring device, etc., needs to be determined or adjusted. The monitoring frequency refers to a frequency at which the gas monitoring device acquires the gas data.

In some embodiments, the supervision management platform clusters all the gas monitoring devices based on the gas data, a location, and a connection relationship of each gas monitoring device to obtain a plurality of clusters. In response to a gas pipeline network region corresponding to a single cluster satisfying a preset condition, the supervision management platform determines the gas pipeline network region corresponding to the single cluster as a monitoring sampling region. The gas pipeline network region refers to a portion of the gas pipeline network enclosed by a plurality of gas monitoring devices. The preset condition includes that a length of the gas pipeline in the gas pipeline network region is greater than a length threshold. The length threshold is preset based on experience. The supervision management platform obtains the location and the connection relationship of the gas monitoring device from a gas company management platform via the government gas supervision sensing network platform.

In some embodiments, after determining a plurality of monitoring sampling regions, the supervision management platform may perform operations 220 to 270 for each of the monitoring sampling regions to determine an updating mixing instruction corresponding to each monitoring sampling region.

In 220, a monitoring frequency of a gas monitoring device within the monitoring sampling region is determined based on a steady-state value of the monitoring sampling region.

The steady-state value is used to reflect the consistency of the gas data collected by the plurality of gas monitoring devices in the monitoring sampling region.

In some embodiments, the supervision management platform determines the steady-state value for the monitoring sampling region in a plurality of ways based on the first gas data. For example, the supervision management platform calculates a composite difference value of the first gas data corresponding to the plurality of gas monitoring devices in the monitoring sampling region, and determines the steady-state value based on the composite difference value. The smaller the composite difference value is, the larger the steady-state value is. The composite difference value is represented by an average of the difference values corresponding to the plurality of pieces of first gas data. The difference values are represented by variances, etc.

In some embodiments, the supervision management platform determines the monitoring frequency based on the steady-state value. The monitoring frequency is negatively correlated to the steady-state value.

In 230, second gas data and gas input information are obtained via the device object platform, and a terminal gas quality is determined based on the second gas data and the gas input information.

The second gas data refers to gas data corresponding to the monitoring sampling region obtained by the device object platform based on the high sampling rate after determining the monitoring frequency. The gas data corresponding to the monitoring sampling region refers to the gas data collected by the plurality of gas monitoring devices in the monitoring sampling region.

In some embodiments, the supervision management platform obtains the second gas data in a similar manner to obtaining the first gas data.

The gas input information refers to information related to the gas input of the gas pipeline network. In some embodiments, the gas input information includes a gas component content, a gas flow rate, etc., of the gas input from a plurality of gas sources (e.g., gas stations, etc.). The gas component content is expressed by a volume percentage corresponding to each gas component (e.g., methane, ethane, etc.).

In some embodiments, the supervision management platform obtains the gas input information from the gas company management platform via the government gas supervision sensing network platform.

The terminal gas quality refers to data characterizing the quality of the gas delivered to a terminal user. The terminal user refers to a gas user corresponding to the monitoring sampling region. The terminal gas quality is expressed by numerical values or grades, etc., and the higher the numerical values or grades, the higher the terminal gas quality.

In some embodiments, the supervision management platform determines the terminal gas quality in a plurality of ways. For example, the supervision management platform constructs a gas transmission map based on the second gas data, the gas input information, a pipeline network connection status in the monitoring sampling region, or the like, and determines the terminal gas quality based on the gas transmission map. The supervision management platform obtains the pipeline network connection status via the gas company management platform.

The gas transmission map refers to a map structure used to reflect the transmission of the gas in the monitoring sampling region. The gas transmission map includes a plurality of nodes and edges.

Edges in the gas transmission map reflect the connection relationships between nodes. If two nodes are connected by a gas pipeline, an edge exists between the two nodes, and a direction of the edge is a gas transmission direction. The most upstream node in the gas transmission map represents the gas source, the most downstream node represents the terminal user, and the intermediate nodes between the most upstream node and the most downstream node represent where the gas mixing devices are located.

In some embodiments, a node feature of a node includes the gas component content and the gas flow rate corresponding to the node. The node feature of the most upstream node is determined based on the gas input information. The gas flow rate corresponding to an intermediate node is obtained based on the second gas data. The gas flow rate of the most downstream node is obtained through a gas entry device.

The gas in the gas transmission map for each node, except the most upstream node, is obtained by mixing gas from an upstream node corresponding to the node. In some embodiments, the supervision management platform takes the nodes other than the most upstream node in the gas transmission map as target nodes, and calculates mixing information and a gas component content of each target node based on the gas flow rate and the gas component content of the upstream node corresponding to each target node.

The mixing information refers to information related to gas mixing. In some embodiments, the mixing information includes a mixing source and a mixing ratio. The mixing source of the target node includes the upstream node corresponding to the target node. The mixing ratio refers to a ratio of gas delivered to the target node by the upstream node corresponding to the target node.

Exemplarily, the upstream nodes of the target node A are node B and node C, and the gas flow rates of node B and node C are 10 m³/s and 15 m³/s, respectively, so that the mixing information of the target node A may be expressed as (B: 40%, C: 60%). If the gas component content of node B is (methane: 90%, ethane: 5%), and the gas component content of node C is (methane: 85%, ethane: 15%), the methane content of target node A is 90%×40%+85%×60%=87%, and similarly, the ethane content of target node A is 10%×40%+15%×60%=13%, i.e., the gas component content of target node A is (methane: 87%, ethane: 13%).

In some embodiments, the supervision management platform determines the gas component content corresponding to each of the target nodes in sequence from upstream to downstream based on the operations described above, and finally obtains the gas component content of the most downstream node.

In some embodiments, the supervision management platform determines the gas component content of the most downstream node based on the gas transmission map. Based on the gas component content of the most downstream node and a calorific value of methane in the gas component, the supervision management platform takes a product of the content of methane in the gas component content and the calorific value of methane as an estimated gas calorific value, and determines the terminal gas quality corresponding to the terminal user based on the estimated gas calorific value. The larger the estimated gas calorific value, the higher the terminal gas quality. The gas calorific value refers to an amount of heat released per unit volume of gas by complete combustion. Due to the main component in gas is methane, the gas calorific value may be expressed in terms of the amount of heat given off per unit volume of methane completely burned. The calorific value of methane is obtained based on manual input or third-party platforms, etc.

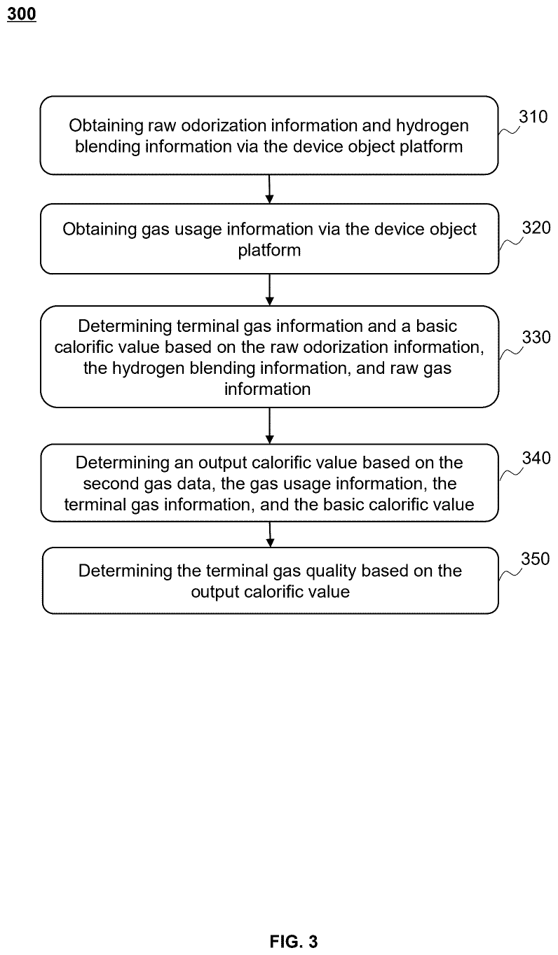

In some embodiments, the supervision management platform determines the terminal gas quality based on the output calorific value, as more fully described in FIG. 3 and related descriptions.

In 240, a terminal user feature is obtained from the gas user platform via the gas company service platform.

The terminal user feature refers to data related to the terminal user corresponding to the monitoring sampling region itself. In some embodiments, the terminal user feature includes at least one of a type of terminal user, historical complaint information, a gas consumption scale, or the like. The type of terminal user includes a residential user, an industrial user, or the like. In some embodiments, when the terminal user refers to an industrial user, the terminal user feature also includes a type of factory, etc.

In some embodiments, the terminal user feature is collected by the gas company service platform from the gas user platform and uploaded to the supervision management platform via the gas company management platform and via the interaction of a plurality of platforms.

In 250, gas regulation data is obtained via the device object platform, and a gas quality requirement is determined based on the terminal user feature and the gas regulation data.

The gas regulation data refers to data related to the regulation of gas by the terminal user. In some embodiments, the gas regulation data includes a frequency of the regulation of the gas flow by the terminal user using the gas entry device, etc.

In some embodiments, the gas regulation data is stored in the device object platform, and the supervision management platform obtains the gas regulation data from the device object platform through the interaction of a plurality of platforms.

The gas quality requirement refers to a requirement of the terminal user for gas quality. In some embodiments, the gas quality requirement is expressed by a reference gas calorific value, and the higher the reference gas calorific value, the higher the gas quality requirement.

In some embodiments, the supervision management platform determines the gas quality requirement in a plurality of ways. For example, the supervision management platform adjusts the reference gas calorific value upward based on the gas regulation data by querying, according to the terminal user feature, the reference gas calorific value corresponding to the terminal user feature in a first preset table. The upward adjustment is positively correlated to the frequency of the regulation of the terminal user for the gas flow.

In some embodiments, the first preset table is preset based on historical data and includes a plurality of terminal user features and reference gas calorific values corresponding to different terminal user features. The supervision management platform may count the gas calorific value of the gas used by the terminal user at a plurality of historical time points, and use the average of the plurality of gas calorific values as the reference gas calorific value. The plurality of historical time points are preset based on experience.

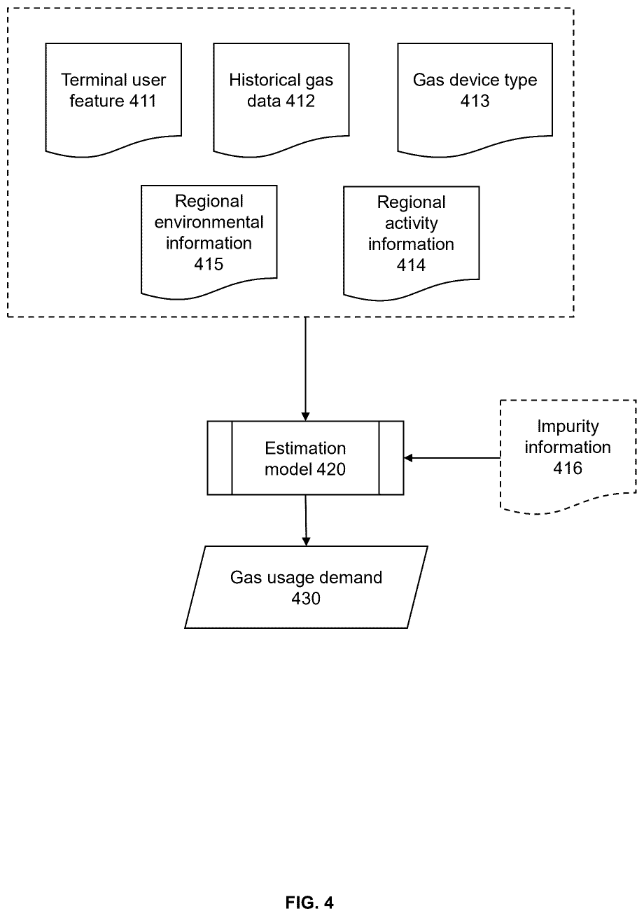

In some embodiments, the supervision management platform determines a gas usage demand using an estimation model and determines the gas quality requirement based on the gas usage demand. More description can be found in FIG. 4 and related descriptions.

In 260, an updating mixing parameter is determined in response to the terminal gas quality not satisfying the gas quality requirement.

The terminal gas quality not satisfying the gas quality requirement includes that a predicted gas calorific value is lower than a reference gas calorific value, etc.

The updating mixing parameter refers to a redefined mixing parameter. The mixing parameter refers to an operating parameter of the gas mixing device in the monitoring sampling region. In some embodiments, the mixing parameter includes an updating mixing ratio. The updating mixing ratio refers to a redefined mixing ratio. The mixing ratio refers to a ratio of different sources of gas. The updating mixing ratio is indicated by valve openings corresponding to different upstream pipelines and the gas mixing device. The larger the valve opening, the more gas the gas mixing device receives from the corresponding upstream pipeline.

In some embodiments, in response to the terminal gas quality not satisfying the gas quality requirement, the supervision management platform may determine updating mixing parameter based on the gas transmission map. For example, the supervision management platform may obtain node features of one or more upstream nodes of the most downstream node in the gas transmission map, adjust gas flow rates of the plurality of upstream nodes based on a plurality of gas component content in the plurality of node features, and adjust a valve opening of the gas mixing device based on the adjusted gas flow rate. The supervision management platform adjusts the gas flow rates of the upstream nodes and the valve opening of the gas mixing device sequentially in the above manner. When adjusting to the most upstream node, the supervision management platform may directly adjust the amount of gas input into the most upstream node (gas source). In some embodiments, the supervision management platform may increase the gas flow rate of an upstream node of the plurality of upstream nodes that has a higher gas calorific value (e.g., a higher methane content) and increase the valve opening of the pipeline between the gas mixing device and that upstream node to increase the ratio of gas with a higher gas calorific value in the mixing ratio, thereby increasing the terminal gas quality.

In some embodiments, the supervision management platform may also obtain gas usage information via the device object platform, determine a user priority based on the gas usage information and the terminal user feature, and determine the updating mixing parameter based on the user priority.

The gas usage information refers to information related to gas usage by the terminal user. In some embodiments, the gas usage information includes an amount of gas usage, image information, and concentration information during gas usage, etc. The image information refers to an image of a flame of gas combustion. The concentration information refers to a concentration sequence of carbon monoxide and carbon dioxide during gas usage.

In some embodiments, the supervision management platform obtains the gas usage information, the image information, and the concentration information via a gas meter, an image sensor, a carbon monoxide sensor, and a carbon dioxide sensor of the device object platform.

The user priority reflects the importance of the terminal user. In some embodiments, the supervision management platform obtains an initial priority of the terminal user by manual input or the like, wherein the initial priority of an industrial user is greater than the initial priority of a residential user.

In some embodiments, the supervision management platform adjusts the initial priority based on the gas usage information to obtain the user priority. The higher the amount of gas usage, and the smaller the fluctuation of the amount of gas usage, the higher the user priority. The magnitude of fluctuation in the amount of gas usage is represented by the variance of the amount of gas usage at a plurality of historical time points.

In some embodiments, the supervision management platform prioritizes determining, based on the user priority, the updating mixing parameter of the upstream gas mixing device of the terminal user with high user priority in the manner described above, so as to satisfy the gas quality requirement of the terminal user with high user priority.

By determining the user priority, it is possible to prioritize meeting the gas quality requirement of the terminal user with high user priority, thereby ensuring the gas usage of the industrial user or the user with higher gas usage.

In 270, an updating mixing instruction is generated based on the updating mixing parameter, and the updating mixing instruction is sent to the gas company management platform, wherein the gas company management platform updates the mixing parameter of the gas mixing device.

The updating mixing instruction refers to an instruction for updating the mixing parameter of the gas mixing device in the monitoring sampling region. In some embodiments, the supervision management platform generates a machine instruction based on the updating mixing parameter, generates the updating mixing instruction based on the machine instruction, and sends the updating mixing instruction to the gas company management platform. The gas company management platform updates the mixing parameter of the gas mixing device in the monitoring sampling region.

By conducting data collection with a high sampling rate in the determined monitoring sampling region, redundant data can be reduced. By estimating the terminal gas quality and determining whether the terminal gas quality satisfies the gas quality requirement, it is possible to quickly determine whether the mixing parameter of the gas mixing device needs to be updated without involving the gas pressure regulation, thus realizing accurate monitoring of gas quality and dynamic adjustment of the gas mixing ratio, which protects the gas usage of the gas user while satisfying their gas quality requirement on time.

FIG. 3 is a flowchart illustrating an exemplary process for determining a terminal gas quality according to some embodiments of the present disclosure. As shown in FIG. 3, process 300 includes the following operations.

In 310, raw odorization information and hydrogen blending information are obtained via the device object platform.

The raw odorization information refers to information related to an odorized gas added to the gas by an odorizing device. In some embodiments, the raw odorization information includes the type and the amount of odorized gas added to the gas by each odorizing device.

The hydrogen blending information refers to information related to the addition of hydrogen to the gas by a hydrogen blending device. In some embodiments, the hydrogen blending information includes the amount of hydrogen blended by each hydrogen blending device.

In some embodiments, the supervision management platform obtains the raw odorization information and the hydrogen blending information through the hydrogen blending device and the odorizing device of the device object platform.

In 320, gas usage information is obtained via the device object platform.

More descriptions regarding the gas usage information may be found in FIG. 4 and the relevant descriptions.

In 330, terminal gas information and a basic calorific value are determined based on the raw odorization information, the hydrogen blending information, and raw gas information.

The raw gas information refers to information related to the gas received by the terminal user when odorized gas and hydrogen are not added to the gas. In some embodiments, the raw gas information includes a gas component content of the gas received by the terminal user. The raw gas information is obtained via the gas transmission map. More descriptions regarding the gas transmission map may be found in FIG. 2 and the relevant descriptions.

The terminal gas information refers to information related to the gas received by the terminal user after the addition of odorized gas and hydrogen to the gas. In some embodiments, the terminal gas information includes a gas component content of the gas received by the terminal user after the addition of the odorized gas and hydrogen to the gas.

In some embodiments, the supervision management platform adds the raw odorization information and the hydrogen blending information to the gas transmission map as node features of the nodes of the gas mixing device corresponding to the odorizing and the hydrogen blending, and recalculates the gas component content of each target node based on the raw odorization information and the hydrogen blending information by the manner of determining the gas component content of the target nodes described in operation 230, and determines the gas component content of the most downstream node as the terminal gas information.

The basic calorific value refers to an estimated calorific value of the gas after odorization and hydrogen blending.

In some embodiments, the supervision management platform may perform a weighted average of the calorific values of all components contained within the gas to obtain the basic calorific value. The calorific values of the components are obtained by manual input, etc. The weights of the different components are positively correlated with the content of the components.

In some embodiments, the supervision management platform obtains gas leakage information in the monitoring sampling region; determines terminal odorization information based on the raw odorization information and the gas leakage information; and determines the terminal gas information and the basic calorific value based on the terminal odorization information, the hydrogen blending information, and the raw gas information.

The gas leakage information refers to information related to gas leakage at the terminal user. In some embodiments, the gas leakage information includes an average amount of gas leakage, an average time of gas leakage, or the like. The supervision management platform obtains the gas leakage information through a leakage monitoring device of the gas user platform. The average time of gas leakage refers to an average time of the gas leakage in cases of a plurality of gas leaks.

The terminal odorization information refers to odorization information corresponding to the gas received by the terminal user.

In some embodiments, the supervision management platform constructs a first target vector based on the raw odorization information and the gas leakage information, matches a first reference vector that satisfies a first matching condition in a first vector database based on the first target vector, and identifies a label corresponding to the first reference vector as the terminal odorization information. The first matching condition includes having a highest vector similarity to the first target vector. The vector similarity is negatively correlated with a vector distance. The vector distance includes Euclidean distance, etc.

In some embodiments, the first vector database is constructed based on the historical data or the experimental data. For example, the supervision management platform constructs the first reference vector based on historical raw odorization information and historical gas leakage information in the historical data or the experimental data, and determines historical terminal odorization information as a label corresponding to the first reference vector.

In some embodiments, the supervision management platform may replace the raw odorization information with the terminal odorization information in the above-described manner for determining the terminal gas information and the basic calorific value, and recalculate to obtain the terminal gas information and the basic calorific value.

In some embodiments, the terminal odorization information is related to regional environmental information.

The regional environmental information refers to information related to the environment in which the terminal user is located. In some embodiments, the supervision management platform may obtain the regional environmental information through manual input or a third-party platform, etc., and add the regional environmental information when constructing the first target vector.

The movement speed and diffusion rate of the gas may vary under different environmental conditions, and adding the regional environmental information to the first reference vector helps to more accurately assess the odorizing effect and thus more accurately determine the terminal odorization information.

Effective deodorization allows the user to realize the gas leak faster and thus deal with it. Determining the terminal odorization information based on the gas leakage information at the terminal user can make the terminal odorization information determined in a more reasonable manner, which is conducive to making the obtained terminal gas information closer to the actual situation, and then more accurately determine the terminal gas information and the basic calorific value.

In 340, an output calorific value is determined based on the second gas data, the gas usage information, the terminal gas information, and the basic calorific value.

More descriptions regarding the second gas data and the gas usage information may be found in FIG. 2 and the relevant descriptions.

The output calorific value refers to a gas calorific value of the gas that the terminal user receives after being odorized and hydrogenated.

In some embodiments, the supervision management platform determines the output calorific value in a plurality of ways. For example, the supervision management platform determines the output calorific value based on the second gas data, the gas usage information, the terminal gas information, and the basic calorific value using a calorific value estimation model.

The calorific value estimation model refers to a model for determining the output calorific value. In some embodiments, the calorific value estimation model refers to a machine learning model, e.g., the calorific value estimation model is a convolutional neural network (CNN) model, or the like.

In some embodiments, the supervision management platform generates the calorific value estimation model based on a plurality of calorific value training samples with calorific value labels. For example, the supervision management platform may input the plurality of calorific value training samples into an initial calorific value estimation model, construct a loss function based on an output of the initial calorific value estimation model and the calorific value labels, and update the initial calorific value estimation model based on the iteration of the loss function, wherein the iteration is terminated when an iteration completion condition is satisfied, and then trained calorific value estimation model is obtained. The iterative updating manner includes a gradient descent manner, or the like. The iteration completion condition includes the loss function convergence or the count of iterations reaching a threshold, etc.

The calorific value training sample includes sample second gas data, sample gas usage information, sample terminal gas information, and a sample basic calorific value corresponding to a sample terminal user. The calorific value training sample is obtained based on the historical data. The calorific value label is the gas calorific value of the gas used by the sample terminal user. The calorific value label is obtained by manual measurement.

In some embodiments, the supervision management platform may also determine an impurity accumulation amount in a gas pipeline based on pipeline information, a pipeline cleaning cycle, and the second gas data; determines impurity information based on the impurity accumulation amount; and determines the output calorific value based on the impurity information, the second gas data, the gas usage information, and the basic calorific value.

The pipeline information refers to information related to gas pipelines. In some embodiments, the pipeline information includes at least one of a pipeline material, a pipeline shape size, a pipeline length, or the like.

The pipeline cleaning cycle refers to a cycle for cleaning impurities from a gas pipeline.

In some embodiments, the supervision management platform obtains the pipeline information and the pipeline cleaning cycle from a government supervision integrated database.

The impurity accumulation amount reflects the accumulation of impurities in the gas pipeline.

In some embodiments, the supervision management platform constructs a second target vector based on the pipeline information, the pipeline cleaning cycle, and the second gas data, and determines the label corresponding to the second reference vector as the impurity accumulation amount based on the second reference vector that is matched by the second target vector and satisfies the second matching condition in the second vector database. The second matching condition includes having the highest vector similarity to the second target vector.

The second vector database is constructed in a manner similar to that of the first vector database, and the manner of realizing the same is described in the manner of constructing the first vector database. The supervision management platform obtains the historical impurity accumulation amount by manual input, etc., and uses the historical impurity accumulation amount as a label corresponding to the second reference vector. The historical impurity accumulation amount is obtained by manual measurement.

The impurity information refers to information related to impurities in the gas pipeline network. In some embodiments, the impurity information includes a total impurity amount at a plurality of locations in the gas pipeline network, etc. The supervision management platform may take the sum of the impurity accumulation amount and an impurity increase amount as a total impurity amount.

In some embodiments, the impurity increase amount is related to the impurity accumulation amount, the pipeline length, and the gas flow rate. The supervision management platform may obtain a fitting function based on a large number of historical impurity accumulation amounts, historical pipeline lengths, historical gas flow rates, and historical impurity increase amounts in the historical data by fitting. The fitting function reflects the correspondence between the impurity increase amount and the impurity accumulation amount, the pipeline length, and the gas flow rate. The fitting manners include least squares, etc.

In some embodiments, the supervision management platform inputs the impurity accumulation amount corresponding to the most upstream node in the gas transmission map, the pipeline length with the most downstream node, and the gas flow rate into the fitting function, and calculates the impurity increase amount corresponding to the most upstream node.

In some embodiments, in determining the impurity increase amount corresponding to each of the target nodes in the gas transmission map, the impurity increase amount may be treated as a gas component, and the impurity increase amount corresponding to each of the target nodes may be calculated by the manner of calculating the gas component content of the target node in operation 230. The impurity increase amount corresponding to the most downstream node (denoting the terminal user) is determined by the above manner.

In some embodiments, the supervision management platform may input the impurity information into the calorific value estimation model to obtain the output calorific value. When the input of the calorific value estimation model includes the impurity information, the calorific value training samples further include sample impurity information corresponding to the sample gas users. The sample impurity information is obtained by manual measurement.

Taking into account the effect of impurities in the gas on the gas calorific value, a more accurate output calorific value is determined based on the impurity information.

In 350, the terminal gas quality is determined based on the output calorific value. More descriptions regarding the terminal gas quality may be found in FIG. 2 and the relevant descriptions

In some embodiments, the supervision management platform determines, based on the output calorific value and the impurity information, a reference gas quality as the terminal gas quality by querying an output calorific value corresponding to the reference gas quality in a second preset table. The second preset table is preset based on manual experience, wherein the greater the output calorific value, the higher the reference gas quality.

In some embodiments, the terminal gas quality is also negatively correlated to the total impurity amount corresponding to the terminal user.

In some embodiments of the present disclosure, taking into account the effects of odorization and hydrogen blending on the gas component content, the basic calorific value determined based on the updated gas component content is more accurate. By determining the output calorific value based on the actual use of the gas and the basic calorific value obtained by theoretical calculations, and assessing the terminal gas quality based on the output calorific value, the obtained terminal gas quality is more in line with the actual situation.

It should be noted that the foregoing descriptions of the process 200 and the process 300 are intended to be exemplary and illustrative only, and do not limit the scope of application of this disclosure. For a person skilled in the art, various corrections and changes can be made to the process 200 and the process 300 under the guidance of this disclosure. However, these corrections and changes remain within the scope of this disclosure.

FIG. 4 is a schematic diagram illustrating an exemplary estimation model according to some embodiments of the present disclosure.

In some embodiments, as shown in FIG. 4, the supervision management platform determines gas usage demand 430 using an estimation model 420 based on a terminal user feature 411, historical gas data 412, a gas device type 413, regional activity information 414, and regional environmental information 415, and determines a gas quality requirement based on the gas usage demand 430.

More descriptions regarding the terminal user feature, the gas quality requirement, and the regional environmental information may be found in FIG. 4 and the relevant descriptions.

The estimation model is a model used to predict the gas usage demand. In some embodiments, the estimation model refers to a machine learning model, e.g., the estimation model refers to a long short-term memory network (LSTM) model, or the like.

The historical gas data refers to data related to the use of gas by the terminal user at the historical time, for example, a historical amount of gas usage, a historical output calorific value, or the like. The historical gas data is obtained based on the historical data.

The gas device refers to a device used by the terminal user. The types of gas devices include water heaters, gas stoves, etc. In some embodiments, the supervision management platform obtains the types of gas devices via the device object platform.

The regional activity information refers to information related to activities in a region where the terminal user is located, for example, an energy-saving policy, a special holiday, or the like. In some embodiments, the supervision management platform obtains the regional activity information by manual input, etc.

The gas usage demand refers to a demand of the terminal user for gas energy in a future period. The gas energy refers to the total heat generated by the gas consumed by the terminal user after combustion.

In some embodiments, the gas usage demand includes the gas energy of the terminal user at a current point and the future period. The future period is preset based on experience and includes a plurality of future time points.

In some embodiments, the estimation model is obtained by training based on a sample dataset, the sample dataset including a plurality of training samples and labels corresponding to the plurality of training samples. The training process of the estimation model is similar to the training process of the calorific value estimation model, which is implemented as described in the training process of the calorific value estimation model.

The training sample includes a sample terminal user feature, sample historical gas data, a sample gas device type, sample regional activity information, and sample regional environmental information corresponding to the sample terminal user. The label corresponding to the training sample is the actual gas energy of the sample terminal user at the time of the collection of the training sample and for a while thereafter. The training sample is obtained based on the historical data. The supervision management platform takes the product of the historical amount of gas usage of the sample terminal user and the historical output calorific value as the actual gas energy of the sample terminal user.

In some embodiments, the training process includes an initial phase and an intensive training phase. In the initial phase, the sample dataset is obtained based on a generalized dataset. In the intensive training phase, the sample dataset is obtained based on historical data of target users.

The initial phase refers to a phase in which the estimation model is not trained for the target users. The target users include terminal users corresponding to the current monitoring sampling region.

In some embodiments, the generalized dataset includes the historical data for terminal users in a plurality of other cities or other regions, etc. The generalized dataset is obtained via a cloud platform or a third-party platform.

The intensive training phase refers to a phase where the estimation model is trained for the target users.

In some embodiments, a proportion of training samples corresponding to different user types of the target users satisfies a preset training condition. The preset training condition includes that the proportion of training samples corresponding to the different user types of the target users is greater than a preset threshold.

In some embodiments, the preset threshold is related to the historical amount of gas usage of the target users of the different user types. For example, the greater the average of the historical amount of gas usage of the plurality of target users corresponding to each user type, the greater the preset threshold.

A mixing complexity is used to characterize the complexity of the gas at the target user. In some embodiments, for each most downstream node in the gas transmission map, the supervision management platform counts the most upstream node that provides gas to the most downstream node, and counts a count of nodes between the most upstream node and the most downstream node as the mixing complexity of the target user corresponding to the most downstream node. If there exists more than one most upstream node that provides gas to the most downstream node, the count of nodes that is the most numerous is used as the mixing complexity of the target user corresponding to the most downstream node.

In some embodiments, the preset training condition relates to the user types and the mixing complexity of the target users. For example, the greater the average of the historical mixing complexity of the plurality of target users corresponding to each user type, the greater the preset threshold.

The initial phase is pre-trained based on the generalized dataset, which allows the model to have a strong generalization ability and adapt to many different application scenarios. The intensive training phase is personalized for the characteristics of specific user groups, which can improve the prediction accuracy for specific users. By adjusting the preset thresholds based on the average historical amount of gas usage and the mixing complexity of user types, it is possible to avoid having too few training samples for certain user types, which can lead to inaccurate predictions of the model for the certain user types.

In some embodiments, as shown in FIG. 4, the input of the estimation model 420 further includes impurity information 416.

More descriptions regarding the impurity information may be found in FIG. 3 and relevant descriptions.

In some embodiments, when the input of the estimation model includes the impurity information, the training sample also includes sample impurity information. The sample impurity information is obtained by manual measurement.

Impurities affect the calorific value of gas, and the presence of impurities affects the performance of gas appliances. Therefore, considering the impurity information in the estimation model can determine the gas usage demand more accurately.

In some embodiments, the supervision management platform calculates an average gas energy of the terminal user in the future period based on the gas energy at the plurality of future time points in the gas usage demand, and calculates a ratio of the average gas energy to the current amount of gas usage to obtain a future gas calorific value. The supervision management platform queries a reference gas calorific value in the first preset table that is the same as the future gas calorific value, and determines the gas quality requirement based on the reference gas calorific value. More descriptions regarding the first preset table and determining the gas quality requirement based on the reference gas calorific value may be found in operation 250 and the relevant descriptions.

Considering that terminal users have different requirements for gas energy at different time points and that it takes time for the actual mix of gas, by determining an average gas energy in the future period using the estimation model, and determining the future calorific value of gas based on the average gas energy and further determining the gas quality requirement, it is possible to meet the changing demand of the terminal users for gas energy as much as possible.

Some embodiments of the present disclosure further provide a non-transitory computer-readable storage medium storing computer instructions, wherein, when reading the computer instructions in the storage medium, a computer implements the method for gas quality monitoring of smart gas pipeline networks based on an Internet of Things (IoT).

In addition, certain features, structures, or characteristics of one or more embodiments of the present disclosure may be suitably combined.

In the event of any inconsistency or conflict between the descriptions,

definitions, and/or use of terminology in the materials cited in this disclosure and those described herein, the descriptions, definitions, and/or use of terminology in this disclosure shall prevail.

What is claimed is:

1. A system for gas quality monitoring of smart gas pipeline networks based on an Internet of Things (IoT), wherein the system comprises a government gas supervision management platform, a government gas supervision sensing network platform, a government gas supervision object platform, a gas company sensing network platform, a device object platform, a gas user platform, and a gas company service platform communicated with each other, the government gas supervision object platform including a gas company management platform; wherein
the government gas supervision management platform is configured to:
obtain first gas data via the device object platform, and determine a monitoring sampling region based on the first gas data;
determine a monitoring frequency of a gas monitoring device within the monitoring sampling region based on a steady-state value of the monitoring sampling region;
obtain second gas data and gas input information via the device object platform, and determine a terminal gas quality based on the second gas data and the gas input information;
obtain a terminal user feature from the gas user platform via the gas company service platform;
obtain gas regulation data via the device object platform, and determine a gas quality requirement based on the terminal user feature and the gas regulation data;
determine an updating mixing parameter in response to the terminal gas quality not satisfying the gas quality requirement; and
generate an updating mixing instruction based on the updating mixing parameter, and send the updating mixing instruction to the gas company management platform, wherein the gas company management platform updates a mixing parameter of a gas mixing device.

2. The system of claim 1, wherein the government gas supervision management platform is further configured to:
obtain gas usage information via the device object platform;
determine a user priority based on the gas usage information and the terminal user feature; and
determine the updating mixing parameter based on the user priority.

3. The system of claim 1, wherein the government gas supervision management platform is further configured to:
obtain raw odorization information and hydrogen blending information via the device object platform;
obtain gas usage information via the device object platform;
determine terminal gas information and a basic calorific value based on the raw odorization information, the hydrogen blending information, and raw gas information;
determine an output calorific value based on the second gas data, the gas usage information, the terminal gas information, and the basic calorific value; and
determine the terminal gas quality based on the output calorific value.

4. The system of claim 3, wherein the government gas supervision management platform is further configured to:
determine an impurity accumulation amount in a gas pipeline based on pipeline information, a pipeline cleaning cycle, and the second gas data;
determine impurity information based on the impurity accumulation amount; and
determine the output calorific value based on the impurity information, the second gas data, the gas usage information, and the basic calorific value.

5. The system of claim 3, wherein the government gas supervision management platform is further configured to:
obtain gas leakage information in the monitoring sampling region, and determine terminal odorization information based on the raw odorization information and the gas leakage information; and
determine the terminal gas information and the basic calorific value based on the terminal odorization information, the hydrogen blending information, and the raw gas information.

6. The system of claim 5, wherein the terminal odorization information relates to regional environmental information.

7. The system of claim 1, wherein the government gas supervision management platform is further configured to:
determine a gas usage demand using an estimation model based on the terminal user feature, historical gas data, a gas device type, regional activity information, and regional environmental information, the estimation model being a machine learning model; and
determine the gas quality requirement based on the gas usage demand.

8. The system of claim 7, wherein the estimation model is obtained by training based on a sample dataset, the sample dataset includes a plurality of training samples and labels corresponding to the plurality of training samples, and a training process includes an initial phase and an intensive training phase, wherein
in the initial phase, the sample dataset is obtained based on a generalized dataset; and
in the intensive training phase, the sample dataset is obtained based on historical data of target users, wherein a proportion of training samples corresponding to different user types of the target users satisfies a preset training condition, and the preset training condition relates to the user types and a mixing complexity of the target users.

9. The system of claim 7, wherein an input of the estimation model includes impurity information.

10. A method for gas quality monitoring of smart gas pipeline networks based on an Internet of Things (IoT), wherein the method is executed by a government gas supervision management platform in a system for gas quality monitoring of smart gas pipeline networks based on an Internet of Things (IoT), the method comprising:
obtaining first gas data via a device object platform, and determining a monitoring sampling region based on the first gas data;
determining a monitoring frequency of a gas monitoring device within the monitoring sampling region based on a steady-state value of the monitoring sampling region;
obtaining second gas data and gas input information via the device object platform, and determining a terminal gas quality based on the second gas data and the gas input information;
obtaining a terminal user feature from the gas user platform via the gas company service platform;
obtaining gas regulation data via the device object platform, and determining a gas quality requirement based on the terminal user feature and the gas regulation data;
determining an updating mixing parameter in response to the terminal gas quality not satisfying the gas quality requirement; and
generating an updating mixing instruction based on the updating mixing parameter, and sending the updating mixing instruction to the gas company management platform, wherein the gas company management platform updates a mixing parameter of a gas mixing device.

11. The method of claim 10, further comprising:
obtaining gas usage information via the device object platform;
determining a user priority based on the gas usage information and the terminal user feature; and
determining the updating mixing parameter based on the user priority.

12. The method of claim 10, wherein the obtaining second gas data and gas input information via the device object platform, and determining a terminal gas quality based on the second gas data and the gas input information includes:
obtaining raw odorization information and hydrogen blending information via the device object platform;
obtaining gas usage information via the device object platform;
determining terminal gas information and a basic calorific value based on the raw odorization information, the hydrogen blending information, and raw gas information;
determining an output calorific value based on the second gas data, the gas usage information, the terminal gas information, and the basic calorific value; and
determining the terminal gas quality based on the output calorific value.

13. The method of claim 12, further comprising:
determining an impurity accumulation amount in a gas pipeline based on pipeline information, a pipeline cleaning cycle, and the second gas data;
determining impurity information based on the impurity accumulation amount; and
determining the output calorific value based on the impurity information, the second gas data, the gas usage information, and the basic calorific value.

14. The method of claim 12, further comprising:
obtaining gas leakage information in the monitoring sampling region, and determining terminal odorization information based on the raw odorization information and the gas leakage information; and
determining the terminal gas information and the basic calorific value based on the terminal odorization information, the hydrogen blending information, and the raw gas information.

15. The method of claim 14, wherein the terminal odorization information relates to regional environmental information.

16. The method of claim 10, further comprising:
determining a gas usage demand using an estimation model based on the terminal user feature, historical gas data, a gas device type, regional activity information, and regional environmental information, the estimation model being a machine learning model; and
determining the gas quality requirement based on the gas usage demand.

17. The method of claim 16, wherein the estimation model is obtained by training based on a sample dataset, the sample dataset includes a plurality of training samples and labels corresponding to the plurality of training samples, and a training process includes an initial phase and an intensive training phase, wherein
in the initial phase, the sample dataset is obtained based on a generalized dataset; and
in the intensive training phase, the sample dataset is obtained based on historical data of target users, wherein a proportion of training samples corresponding to different user types of the target users satisfying a preset training condition, and the preset training condition relates to the user types and a mixing complexity of the target users.

18. The method of claim 16, wherein an input of the estimation model includes impurity information.

19. A non-transitory computer-readable storage medium storing computer instructions, wherein when reading the computer instructions in the storage medium, a computer implements the method of claim 10.
